(19) United States
(12) Patent Application Publication
(10) Pub. No.: US 2002/0143630 A1
(43) Pub. Date: Oct. 3, 2002

(54) Method and apparatus for serving or delivering advertisements for a world wide web page

(76) Inventors: Jonas L. Steinman, Englewood Cliffs, NJ (US); Frank W. Daugherty, Old Greenwich, CT (US)

Correspondence Address: BUCKLEY, MASCHOFF, TALWALKAR, & ALLISON, 5 ELM STREET, NEW CANAAN, CT, 06840, US

(21) Appl. No.: 10/043,888

(22) Filed: Jan. 10, 2002

Related U.S. Application Data
(60) Provisional application No. 60/260,791, filed on Jan. 10, 2001.

(51) Int. Cl. G06F 17/60

(52) U.S. Cl. 705/14; 345/781

(57) ABSTRACT

A method and apparatus for allowing advertisements created for one type of media, such as newspapers and magazines, to be used on Web sites and served or downloaded to users for viewing as well as for allowing branding components to be displayed in addition to advertisements.

### CROSS-REFERENCE TO RELATED APPLICATION

This application is based on, and claims priority to, provisional patent application filed Jan. 10, 2001, having application Ser. No. 60/260,791 and entitled Method and Apparatus for Serving or Delivering Advertisements for a World Wide Web Page, the contents of all of which are herein incorporated by reference.

### BACKGROUND OF THE INVENTION

1. Field of the Invention:

This invention relates generally to a method and apparatus for serving or delivering advertisements over the World Wide Web and, more particularly, to a method and apparatus for serving and delivering magazine advertisements and other media advertisements over the World Wide Web.

2. Description of the Prior Art:

The World Wide Web (the “Web”) provides a breadth and depth of information to users. Typically, a user accesses portions of the information by visiting a World Wide Web site (“Web site”). For example, a user interested in learning more about the history and collection National Gallery of Art in Washington, D.C., USA, may visit its Web site (www.nga.gov). A user desiring to learn more about the products available at Nordstoms may visit the company's Web site at www.nordstoms.com.

Companies and merchants typically develop and operate Web sites to make their information about themselves and their goods and services more readily available to potential customers or other interested parties. Many Web sites feature or provide advertising on one or more or their associated Web pages. Advertising space on Web sites is often sold in a manner similar to advertising space sold for other media outlets, such as billboards, magazines, television stations, radio stations, etc. That is, advertisers, advertising agencies, etc. purchase advertising space on a Web page.

An advertisement may be displayed on a Web page according to a number of different arrangements. For example, a Web site may display an advertisement on one of the Web pages for the Web site permanently. Alternatively, the Web site may rotate multiple advertisements on a given space on a Web page. The duration of each advertisement may be short (e.g., a few seconds) or long (e.g., as long as the Web page displayed). For a Web site that provides online searching capabilities, such as the Web portal at www.iwon.com operated by iWon, Inc., an advertisement shown to a visitor to the Web site may be based, at least in part, on search keywords provided or entered by the visitor. For example, a visitor entering the term “watch” as a keyword may be shown advertisements from one or more watch manufacturers.

Often, an advertisement on a Web site is a graphic image that runs on a Web page or is positioned in space on the Web page dedicated for advertisements. Such advertisements on a Web site may be animated GIF (Graphics Interchange Format) images, since animation often attracts a viewer's attention. Many conventional sizes for advertisements on Web pages have been developed and established by the Internet Advertising Bureau. For example, Web page advertisements commonly referred to as banners often have a size of 468×60 pixels. Web page advertisements commonly referred to as buttons often have a size of 120×60 pixels. Using conventional Web based advertising sizes allows both advertisers and Web site operators and developers to efficiently develop and implement Web based advertising.

Unfortunately, the conventional and well-established advertising sizes for Web sites may require some advertisers implementing an advertising campaign across multiple or other media platforms to develop new or different advertisements for each media platform. For example, a company running an advertisement in a magazine may need to change the advertisement significantly to run or use the advertisement on a Web site, particularly since magazine advertisements have different sizing conventions than do Web site advertisements and magazines advertisements are not animated. In addition to problems with the use of print based advertising materials on a Web site, conventional Web based advertising is becoming less effective as visitors to Web sites are becoming increasingly likely to ignore the advertising.

Thus, despite the state-of-the-art in advertising methods and media platforms, there remains a need for a method and apparatus for allowing advertisements created for one type of media, such as newspapers and magazines, to be used on Web sites. In addition, there remains a need for a method and apparatus for new forms and implementations of advertising on Web pages of Web sites.

### SUMMARY OF THE INVENTION

Accordingly, it is an object of the present invention to provide a method and apparatus for allowing advertisements created for one type of media, such as newspapers and magazines, to be used on Web sites. Another object of the present invention is to provide a method and apparatus for creating new forms and implementations of advertisements for use on Web sites, Web pages, etc.

Additional objects, advantages, and novel features of the invention shall be set forth in part in the description that follows, and in part will become apparent to those skilled in the art upon examination of the following or may be learned by the practice of the invention. The objects and the advantages may be realized and attained by means of the instrumentalities and in combinations particularly pointed out in the appended claims.

To achieve the foregoing and other objects and in accordance with the purposes ofthe present invention, as embodied and broadly described herein, a method for serving an electronic version of a print advertisement on a World Wide Web site may include preparing an electronic version of a print advertisement; serving a Web page; and serving a full form of said print advertisement on the Web page. In another embodiment of a method in accordance with the present invention, a method for serving an advertisement on a World Wide Web site may include serving a brand component; serving a small form of an advertisement; and serving a large form of the advertisement. In some embodiments, one or more of the brand component, small form advertisement, and/or large form advertisement may not be used. In yet another embodiment, a method for serving an electronic version of a print advertisement on a World Wide Web site may include preparing an electronic version of a print advertisement; serving a Web page; and serving at least a portion of the electronic version of the print advertisement on the Web page. In a further embodiment, a method for serving an advertisement on a World Wide Web site may include serving a first Web page having a brand component, wherein the first Web page is not resizable by a viewer using browser software; and serving a second Web page having a first form of an advertisement such that the first Web page is not viewable to the viewer. In still another embodiment, a method for serving an advertisement on a World Wide Web site may include serving a first Web page having a first form of an advertisement, wherein the first Web page is not resizable by a viewer using browser software; and serving a second Web page having a second form of the advertisement such that the first Web page is not viewable to the viewer. In still another embodiment, a method for serving an advertisement on a World Wide Web site may include serving a first window having a brand component, wherein the first window is not resizable by a viewer using browser software; and serving a second window having a first form of an advertisement such that the first window is not viewable to the viewer. In yet another embodiment, a method for serving an advertisement on a World Wide Web site may include serving a first window having a first form of an advertisement, wherein the first window is not resizable; and serving a second window having a second form of the advertisement such that the first window is not viewable to the viewer. In yet another embodiment, a method for serving an advertisement may include serving at least one of a first window or Web page having a brand component, wherein the at least one of a window or Web page is configured to display for a period of time when it is displayed on a user device; and after the period of time has elapsed, automatically serving at least one of a second window or Web page having a first form of the advertisement, wherein the at least one of a second window of Web page is configured such that the at least one of a second window or Web page is displayed full screen when it is displayed on the user device. In a further embodiment, a method for serving an advertisement may include serving at least one of a first window or Web page having a first form of an advertisement, wherein the at least one of a first window or Web page is configured to display for a period of time when displayed on a user device; and after the period of time has elapsed, automatically serving at least one of a second window or Web page having a second form of the advertisement, wherein the at least one of the second window or Web page is configured to display full screen when it is displayed on the user device. In a further embodiment, a method for serving an advertisement may include serving at least one of a window or Web page having an advertisement, wherein the at least one of a window or Web page is configured to display for a first period of time on a user device and to display full screen on the user device, wherein the at least one of a window or Web page is configured so that it is not resizable during at least a portion the first period of time. In yet another embodiment, a method for serving an advertisement may include serving at least one of a window or Web page having an advertisement, wherein the at least one of a window or Web page is configured to display full screen on a user device for a period of time, wherein the at least one of a window or Web page is configured so that it is not resizable with browser software during at least a portion of the period of time, and wherein the at least one of a window of Web page is configured to scroll the advertisement. In another embodiment, a method for serving an advertisement may include serving at least one of a first window or Web page having a first form of an advertisement, wherein the at least one of a first window or Web page is configured to display full screen for a first period of time on a user device and has a fixed size during the first period of time; and after the period of time has elapsed, automatically serving at least one of a second window or Web page having a second form of the advertisement, wherein the at least one of a second window or Web page is configured to display full screen on the user device for a second period of time and has a fixed size during the second period of time.

Also to achieve the foregoing and other objects and in accordance with the purposes of the present invention, as embodied and broadly described herein, a system for serving an electronic version of a print advertisement on a World Wide Web site includes a memory; a communication port; and a processor connected to said memory and said communication port, said processor being operative to prepare an electronic version of a print advertisement; serve a Web page; and serve a full form of the print advertisement on the Web page. In another embodiment of a system in accordance with the present invention, a system for serving an advertisement on a World Wide Web site includes a memory; a communication port; and a processor connected to said memory and said communication port, said processor being operative to serve a brand component; serve a small form of an advertisement; and serve a large form of the advertisement. In additional embodiments ofthe system, the processor may be operative to implement other methods described above and herein.

In addition to the above, in another manner to achieve the foregoing and other objects in accordance with the purposes of the present invention, as embodied and described herein, a computer readable medium for use in a server hosting a World Wide Web site, the computer readable medium storing a computer program comprising computer readable means for establishing an electronic version of a print advertisement; computer readable means for downloading a Web page; and computer readable means for downloading a full form of the print advertisement on the Web page. In another embodiment of a computer readable medium in accordance with the present invention, a computer readable medium for use in a server hosting a World Wide Web site, the computer readable medium storing a computer program comprising computer readable means for providing a brand component; computer readable means for providing a small form of an advertisement; and computer readable means for providing a large form of the advertisement. In another embodiment of the present invention, a computer program for use in displaying an advertisement is operative to display at least one of a window or Web page having an advertisement, wherein said at least one of a window or Web page is configured to display for a period of time on a user device and to display full screen on said user device, wherein said at least one of a window or Web page also is configured so that it is not resizable during at least a portion said period of time. In yet another embodiment of the present invention, a computer program for use in displaying an advertisement is operative to display at least one of a first window or Web page having a first form of an advertisement, wherein the at least one of a window or Web page is configured to display for a period of time on a user device; and after the period of time has elapsed, automatically display at least one of a second window or Web page having a second form of the advertisement such that said at least one of a second window or Web page is displayed full screen on the user device. In other embodiments, computer readable means may be configured to implement other methods described above and herein.

In addition to the above, in another manner to achieve the foregoing and other objects in accordance with the purposes of the present invention, as embodied and described herein, an apparatus for serving an advertisement includes means for establishing an electronic version of a print advertisement; means for downloading a Web page; and means for downloading a full form of the print advertisement on the Web page. In other embodiments, an apparatus may include means for performing the steps of the methods described above and herein.

In another embodiment of an apparatus in accordance with the present invention, an apparatus for serving an advertisement includes means for providing a brand component; means for providing a small form of an advertisement; and means for providing a large form of the advertisement.

### BRIEF DESCRIPTION OF THE DRAWINGS

The accompanying drawings, which are incorporated in and form a part of the specification, illustrate the preferred embodiments of the present invention, and together with the descriptions serve to explain the principles of the invention.

### In the Drawings

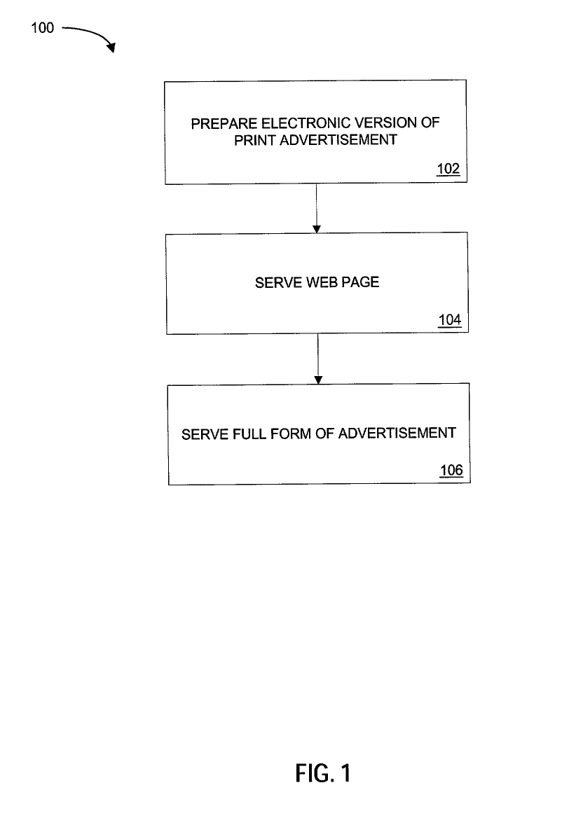

FIG. 1 is a flowchart of a first embodiment of a method in accordance with the present invention;

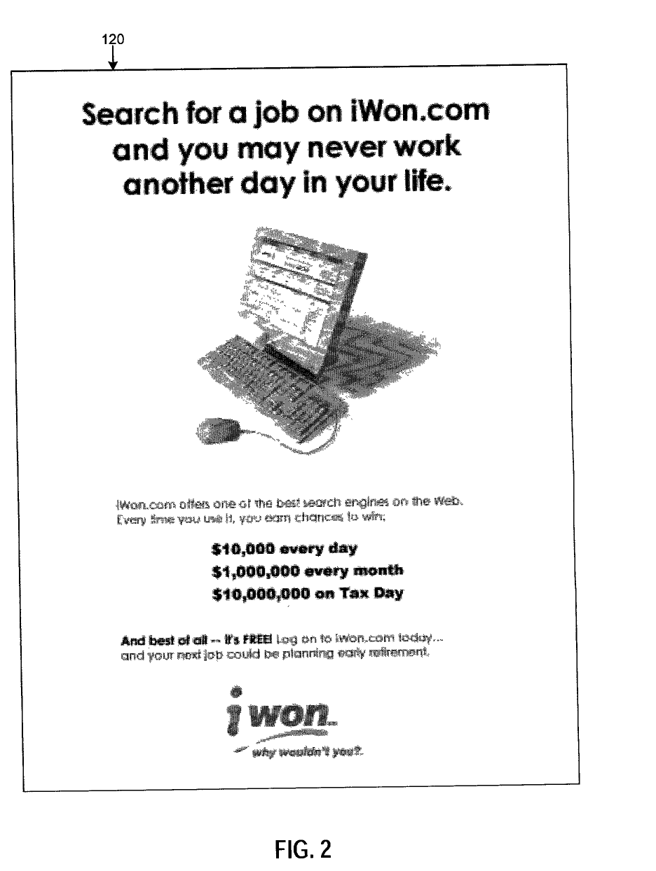

FIG. 2 is an illustration of a print advertisement that maybe used with the method of FIG. 1;

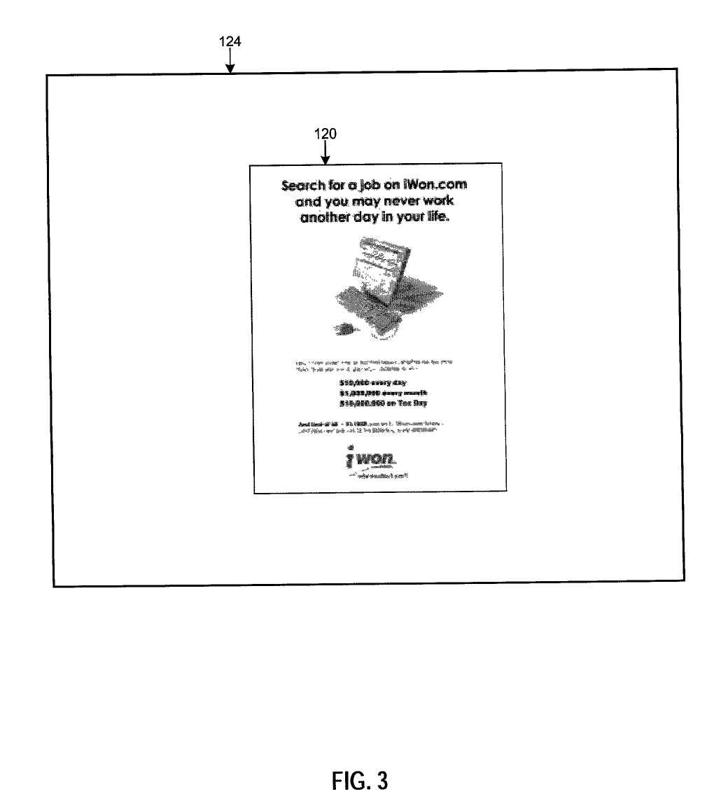

FIG. 3 is an illustration of a Web page on which an electronic version of the print advertisement of FIG. 2 may be displayed;

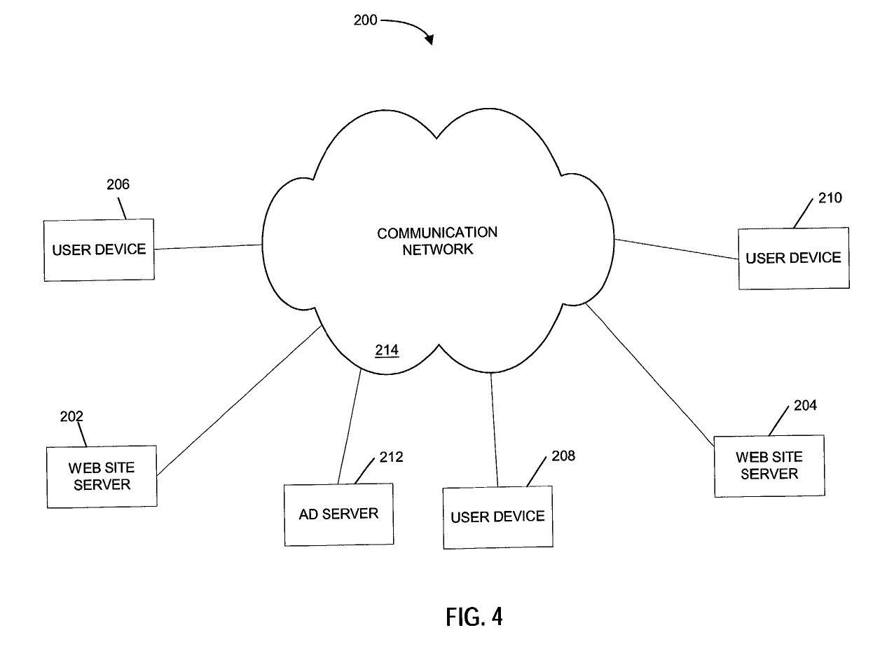

FIG. 4 is a block diagram of system components for an embodiment of an apparatus usable with the method of FIG. 1;

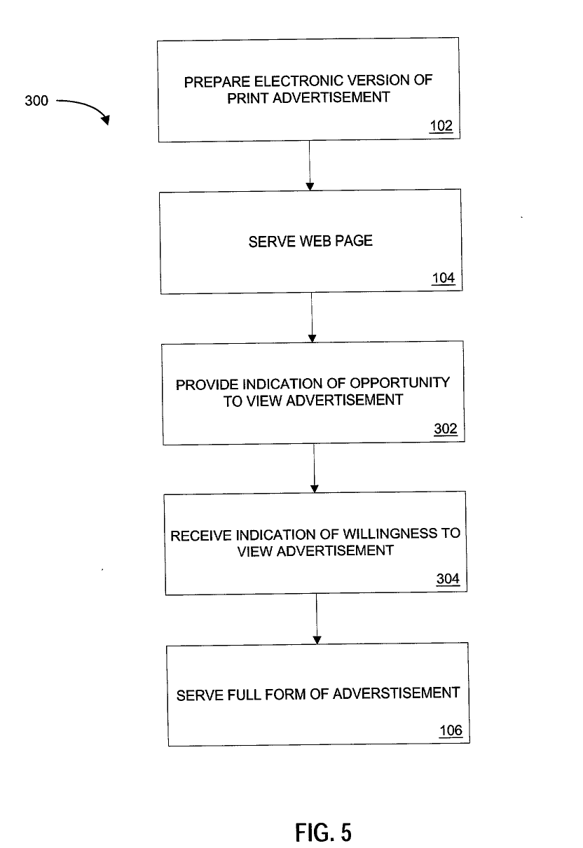

FIG. 5 is a flowchart of a second embodiment of a method in accordance with the present invention;

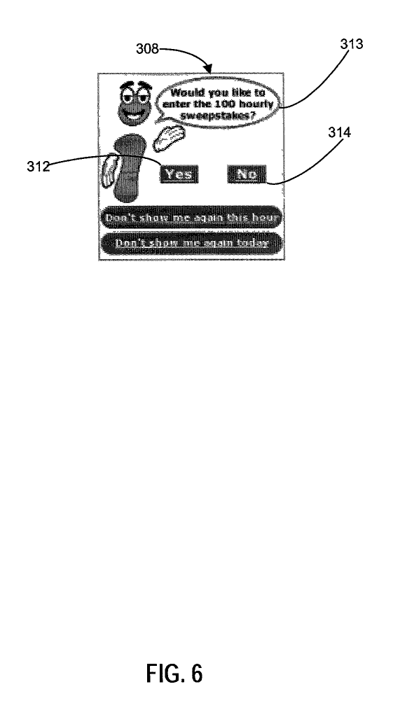

FIG. 6 is an illustration of a pop-up window that may be used with the method of FIG. 5;

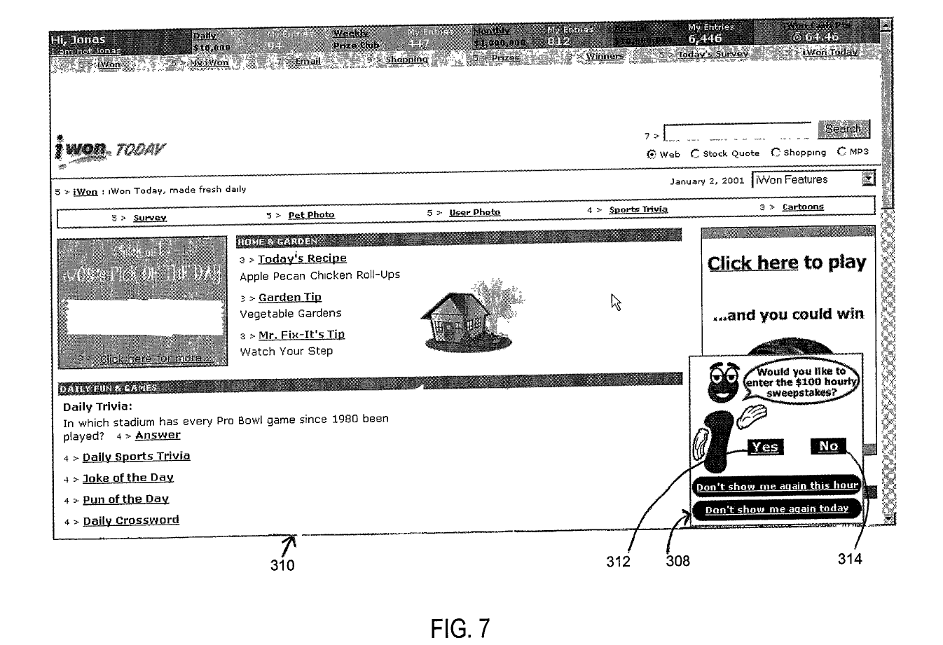

FIG. 7 is an illustration of the pop-up window of FIG. 6 used with a Web page;

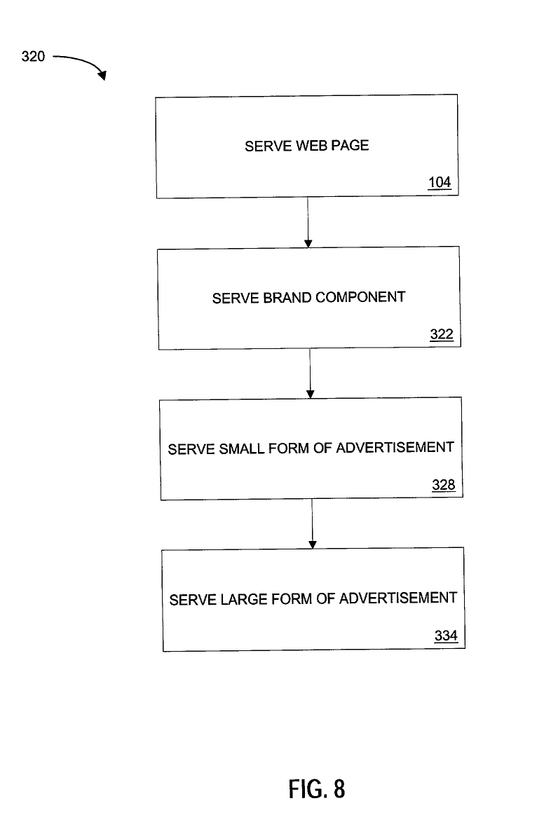

FIG. 8 is a flowchart of a third embodiment of a method in accordance with the present invention;

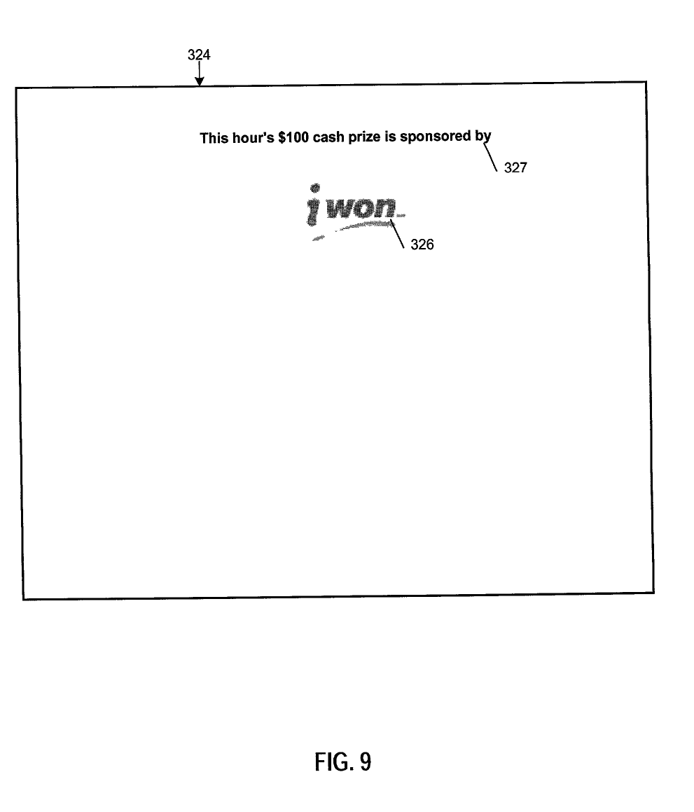

FIG. 9 is an illustration of brand component Web page displayed during the method of FIG. 8;

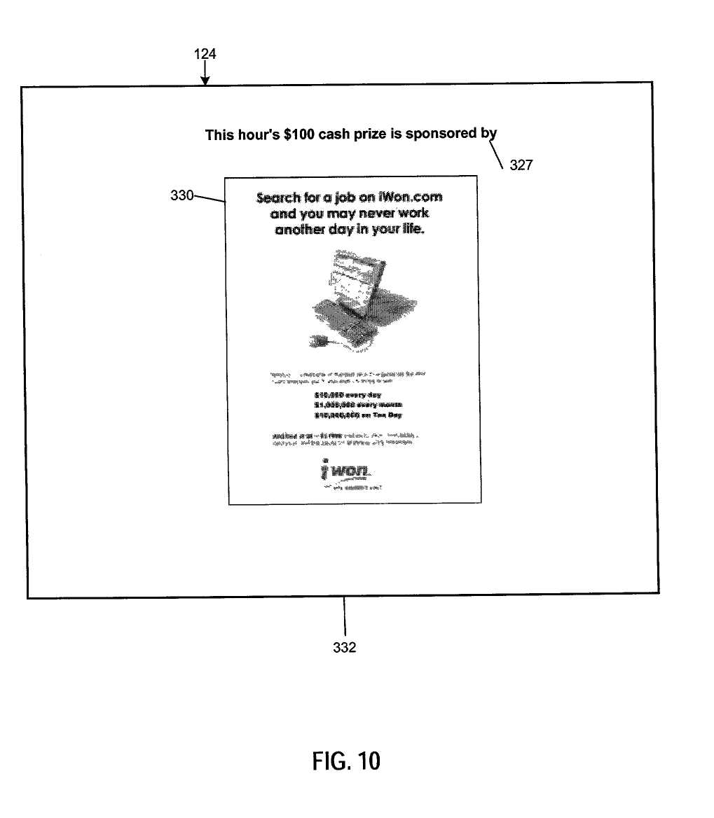

FIG. 10 is an illustration of a Web page and a small form advertisement displayed during the method of FIG. 8;

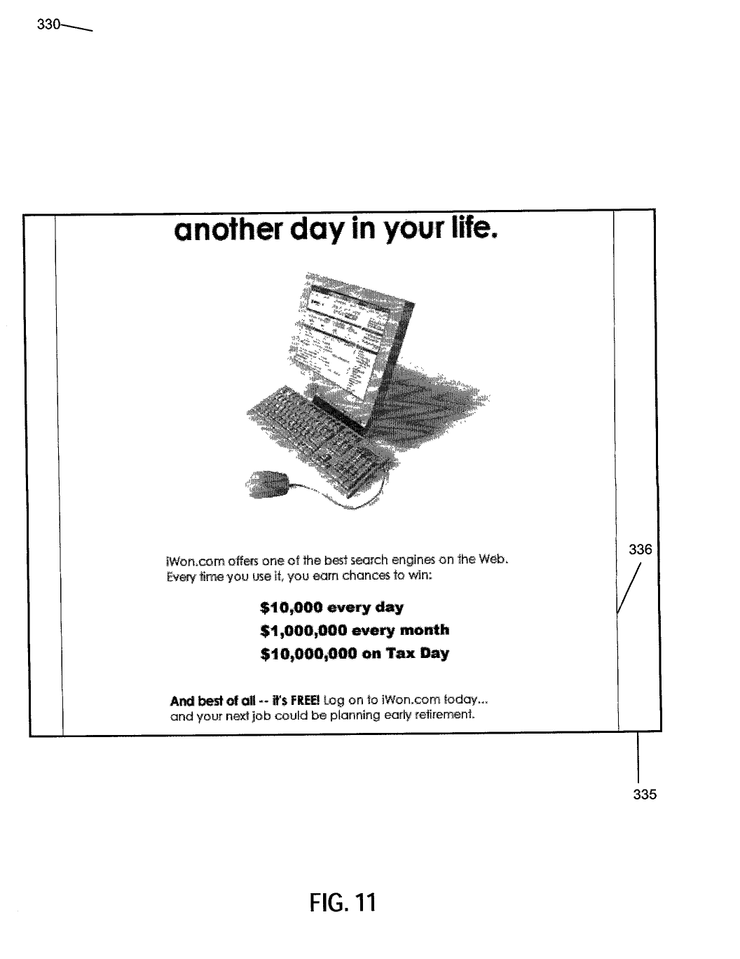

FIG. 11 is an illustration of a Web page and a large form advertisement displayed during the method of FIG. 8;

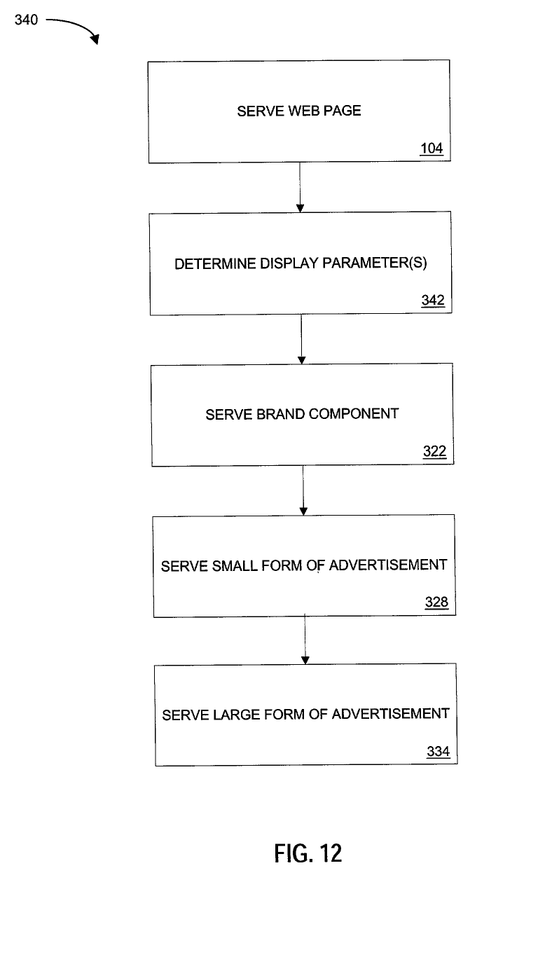

FIG. 12 is a flowchart of a fourth embodiment of a method in accordance with the present invention;

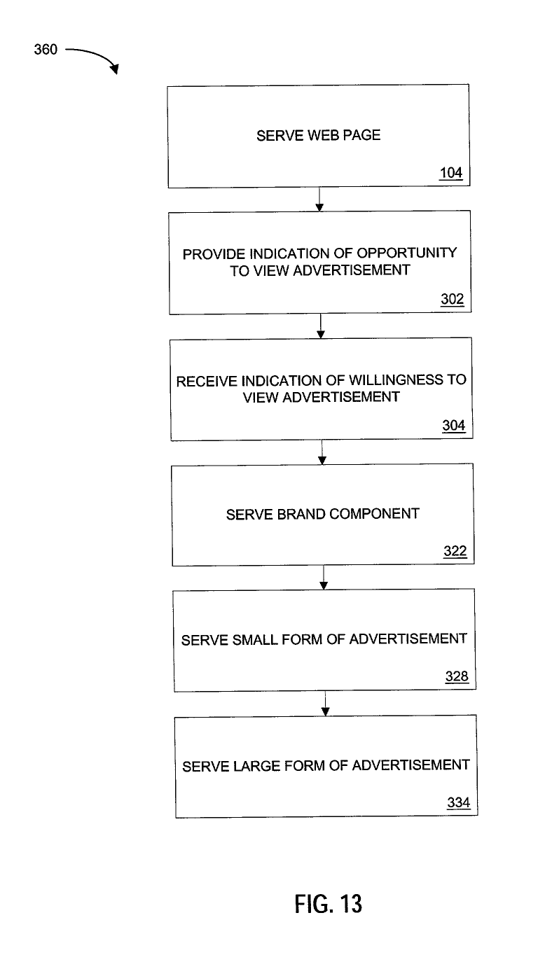

FIG. 13 is a flowchart of a fifth embodiment of a method in accordance with the present invention;

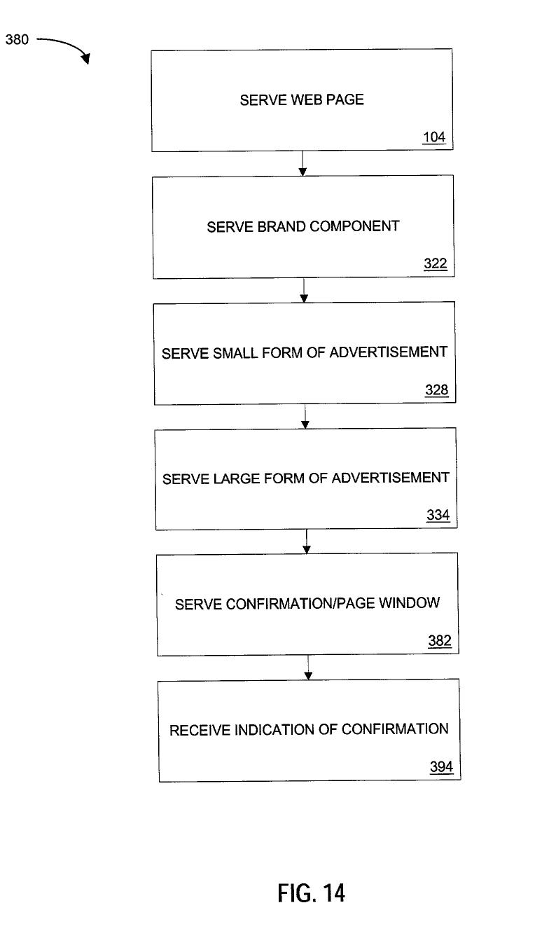

FIG. 14 is a flowchart of a sixth embodiment of a method in accordance with the present invention;

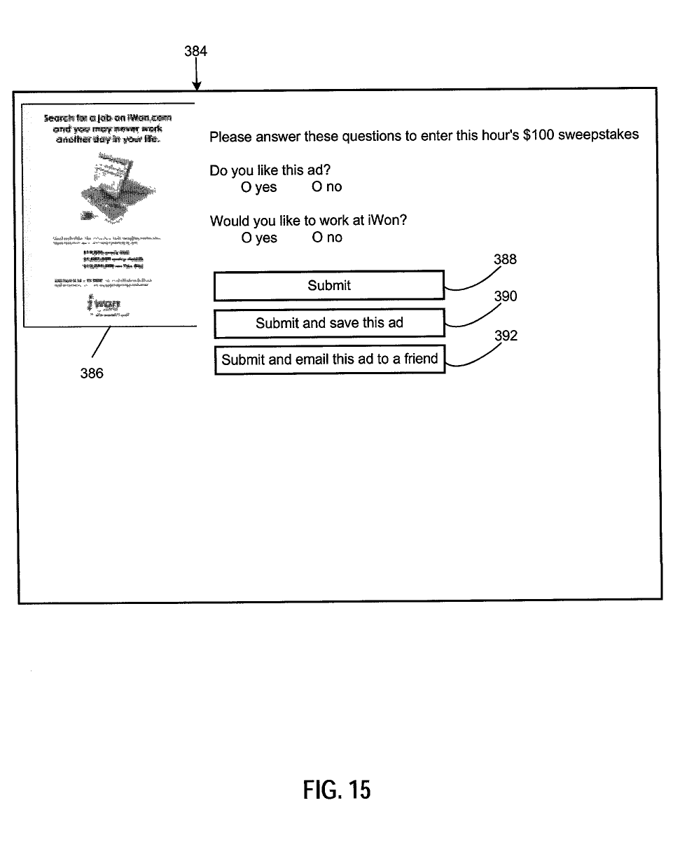

FIG. 15 is an illustration of a Web page that may be used during the method of FIG. 14;

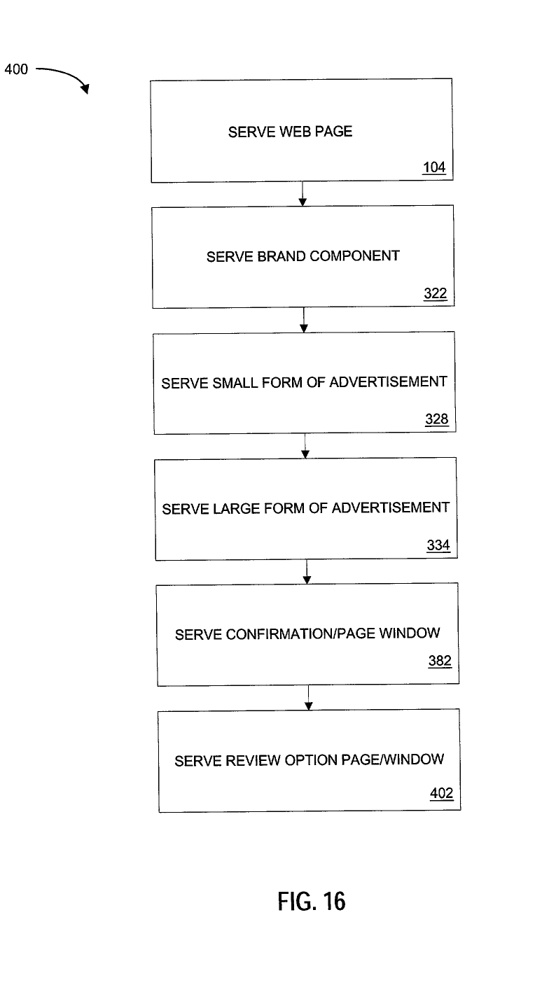

FIG. 16 a flowchart of a seventh embodiment of a method in accordance with the present invention;

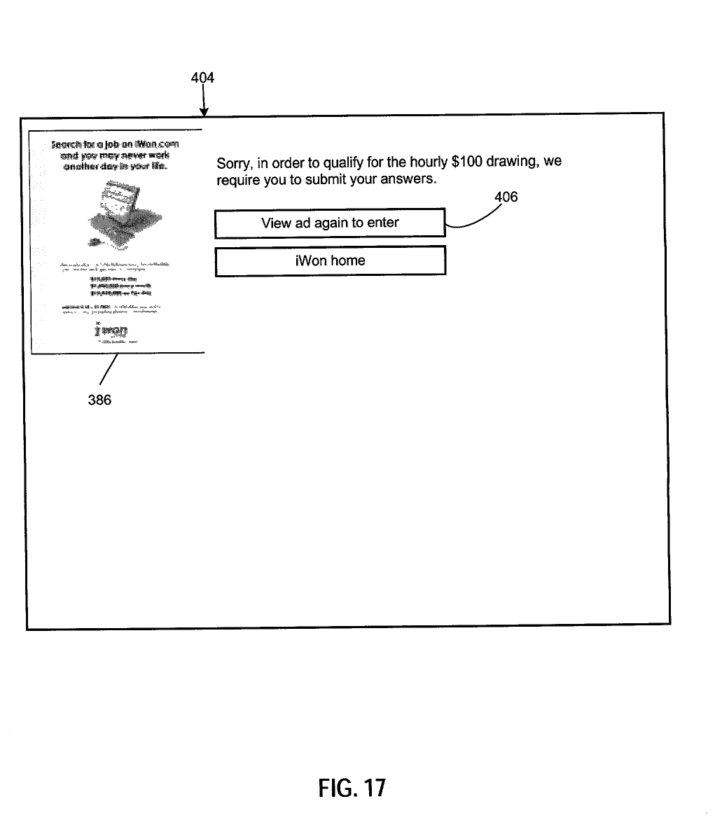

FIG. 17 is an illustration of a Web page that may be used during the method of FIG. 16;

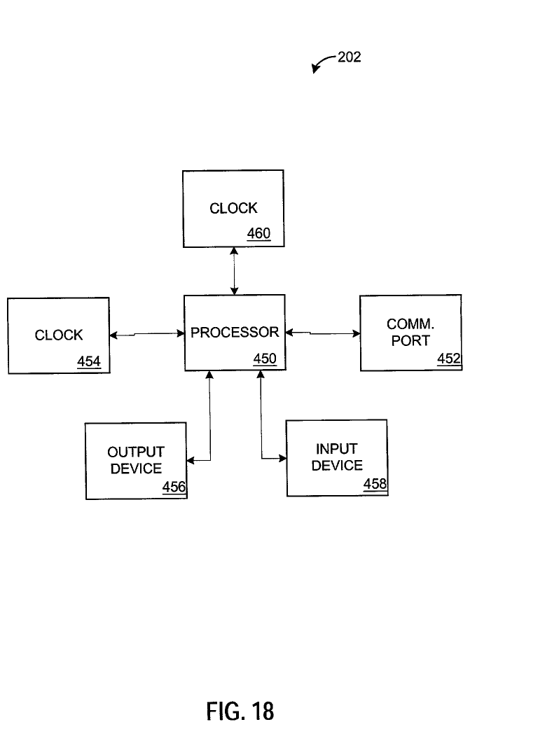

FIG. 18 is a block diagram illustrating a representative Web site server of FIG. 4; and

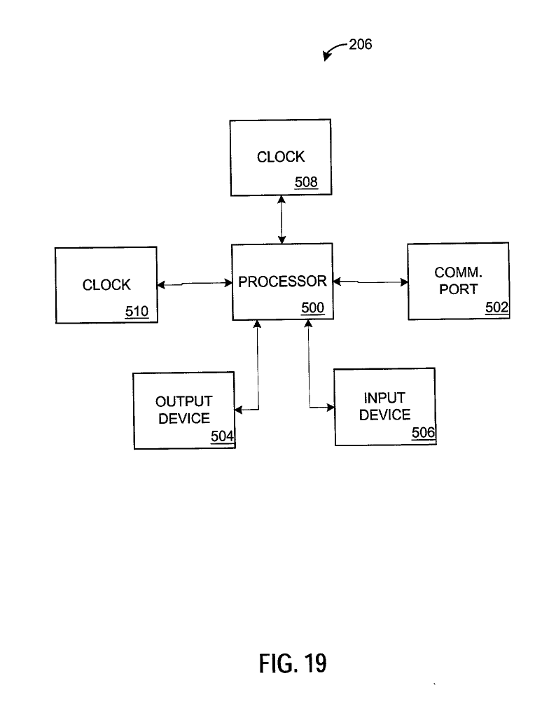

FIG. 19 is a block diagram illustrating a representative user device of FIG. 4.

### DETAILED DESCRIPTION OF THE EMBODIMENTS

A first embodiment 100 of a method in accordance with the principles of the present invention is illustrated in FIG. 1. The method 100 allows a print advertisement, such as an advertisement to be used in magazines and newspapers, to be used on Web sites, thereby obtaining a greater return on the time and money spent to create the print advertisement.

The method 100 may be implemented by a server, controller or other computer. In some embodiments, the method 100 may be implemented by a server that hosts or operates a Web site.

The method 100 illustrated in FIG. 1 includes a step 102 during which an electronic version of a print advertisement is prepared. The electronic version of the print advertisement may be received from an advertiser, ad server, or other device, entity, or source. Alternatively, the electronic version may be created by scanning an actual physical copy of a print advertisement received from the advertiser, ad server, or other device, entity, or source. Regardless of what print medium the print advertisement was originally designed for, the electronic version of the print advertisement is generally comparable to the format the advertisement was originally created in. That is, the electronic version of the print advertisement is not the conventional formats and sizes used for advertisements on Web pages of Web sites.

As used herein, the term “advertisement” should be construed broadly. An advertisement may include graphic or image components, text components, trademark components, etc. For example, a magazine advertisement may include many different components, each of which helps create the overall impression or impact of the advertisement. As used herein, the term “print advertisement” will generally refer to an advertisement that is distributed or used in print medium, such as in a magazine, periodical, newspaper, book, brochure, etc.

The step 102 may be implemented by a Web site server or computer system that hosts and operates a Web site on which the advertisement received during the step 102 will be displayed. Typically, the Web site will be hosted and served by a controller or other Web site server. The Web site may be accessed by a visitor using browser software operating on a computer or other user device.

The method 100 also includes a step 104 during which a Web page of a Web site is downloaded, distributed, or otherwise served to a visitor accessing the Web site. The Web page served during the step 104 may be the home page of the Web site or another Web page of the Web site. The step 104 may be implemented a long time after the step 102 or even before the step 102.

After the Web page is served during the step 104, a full form of the advertisement received during the step 102 is served or otherwise displayed in conjunction with the Web page served during the step 104. Since the advertisement may not fit the conventional sizes used for advertisements on Web pages, the advertisement served during the step 106 may be served in its own Web page or on a significant portion of the Web page served during the step 104. The server or other device that served the Web page during the step 102 may serve the full form of the advertisement during the step 104. Alternatively, serving of the full form of the advertisement during the step 104 may occur by redirecting a request from browser software to an ad server that that transmits the full form of the advertisement. Thus, the term “serving” as used herein with regard to serving of an advertisement by a server, shall be deemed to include redirecting by the server of a request from a user device for an advertisement to an ad server or another device that will transmit or provide the advertisement to the device making the request. Such HTTP (hypertext transfer protocol redirects commonly are used to provide Web based advertising.

Now referring to FIG. 2, an example version of a print advertisement 120 is illustrated that may be used or displayed in a magazine. During the step 102, the print advertisement 120 may be scanned to create an electronic version of it. Alternatively, if the print advertisement 120 was originally created with computer software, an electronic version of the print advertisement may be generated by the software and retrieved or received during the step 102. Due to the size and shape of the advertisement 120, which may be the size and shape of a typical piece of paper (i.e., 8½ inches by 11 inches), the advertisement 120 does not fit the conventional sizes and shapes of Web based advertising. In addition, conforming the print advertisement 120 to fit conventional Web page advertising sizes may require editing, cropping or other significant alteration of the print advertisement 120, thereby significantly changing, if not completely destroying the impression and impact created by the advertisement and requiring additional artistic and technical effort that the method 100 is intended to avoid.

An electronic version 122 of the advertisement 120 maybe displayed in or on its own Web page or window 124 during the step 106, either with or without other materials or information, as illustrated in FIG. 3. The window or Web page 124 containing the electronic version 122 of the print advertisement 120 may override the Web page served to the visitor during the step 104 and be presented to the visitor in full screen format.

The advertisement 122 may be resized so that it does not have same size as it had in the magazine. However, the advertisement 122 served during the step 106 does not to be cropped or edited and generally will have the same shape and proportions as the original print advertisement 120, thereby creating a similar impression and impact as the original print advertisement 120. The electronic version 122 may be scrolled on the window or Web page 124, either manually by a visitor viewing the page or automatically by browser software. Scrolling the advertisement 122 may be particularly useful if the advertisement 122 can not be viewed completely at any one time on a window or Web page.

Now referring to FIG. 4, an apparatus or system 200 usable with the method 100 and the other methods disclosed herein is illustrated. The apparatus 200 includes one or more Web site servers or controllers 202, 204 that may communicate directly or indirectly with one or more user devices 206, 208, 210 or one or more ad servers 212 via a computer, data, or communications network 214. For purposes of further explanation and elaboration of the method 100, the method 100 will be assumed to be operating on the Web site server 202.

The server 202 may implement or perform the steps 102, 104 106 of the method 100. In addition, the server 202 may implement or perform some of all of the steps of the embodiments of the method of the present invention disclosed herein. The server 202 may implement or host a Web site that users can access via the communications network 214. For example, the server 202 maybe the server implementing orhosting the Web site found at www.iwon.com. A server can comprise a single device or computer, a networked set or group of devices or computers, a workstation, etc. In some embodiments, a Web site server may also function as an ad server, database server and/or as a user device. The use, configuration and operation of the Web site server 202 will be discussed in more detail below.

The user devices 206, 208, 210 preferably allow users to interact with the server 202 and the remainder of the apparatus 200. The user devices 206, 208, 210 may also enable a user to access Web sites hosted or operated by the servers 202 and 204. If desired, the user devices 206, 208, 210 may also be connected to or otherwise in communication with other devices. Possible user devices include a personal computer, portable computer, mobile or fixed user station, workstation, network terminal or server, cellular telephone, kiosk, dumb terminal, personal digital assistant, etc. The use, configuration and operation of user devices will be discussed in more detail below.

The ad server 212 typically is used or accessed by the Web site server 202 to serve advertisements on Web pages served by the Web site server 202, such as the Web page served during the step 104. The Web site server 202 may work in conjunction with one or more ad servers to display and serve advertisements in conjunction with Web sites and Web pages.

The use of ad servers to serve advertisements on Web pages and Web sites is well known to people of skill-in-the-art. In addition, further information regarding the use and serving of advertisements on terminals, interactive systems, Web pages, Web sites, etc. can be found in U.S. Pat. No. 6,161,127 issued to Cezar et al., U.S. Pat. No. 6,128,651 issued to Cezar, U.S. Pat. No. 6,014,698 issued to Griffiths, U.S. Pat. No. 5,937,392 issued to Alberts, U.S. Pat. No. 5,959,623 issued to van Hoff et al., U.S. Pat. No. 5,948,061 issued to Merriman et al., U.S. Pat. No. 5,946,646 issued to Schena et al., and U.S. Pat. No. 5,305,195 issued to Murphy, the complete disclosures of all of which are incorporated herein by reference.

Many different types of implementations or hardware configurations can be used in the system 200 and with the method 100 and the methods disclosed herein are not limited to any specific hardware configuration for the system 200 or any of its components.

The communications network 214 might be or include the Internet, the World Wide Web, or some other public or private computer, cable, telephone or communications network or intranet, as will be described in further detail below. The communications network 214 illustrated in FIG. 4 is only meant to be generally representative of cable, computer, telephone or other communication networks for purposes of elaboration and explanation of the present invention and other devices, networks, etc. may be connected to the communications network 214 without departing from the scope of the present invention. The communications network 214 can also include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a Web site server without departing from the scope of the present invention.

Now referring to FIG. 5, a second embodiment 300 of a method in accordance with the present invention is illustrated. For purposes of explanation of the method 300, the server 202 will be assumed to be implementing the method 300. The method 300 includes the steps 102, 106 and 108 previously discussed above. During the step 104, a Web page is served to a visitor to a Web site.

In addition to the steps 102, 104, and 106, the method 300 includes a step 302 during which an indication is provided to the visitor that provides the visitor an opportunity to receive or download the advertisement for which an electronic version was created during the step 102. The indication may be provided on the Web page served during the step 104 as text material, a banner advertisement, an image, etc. Alternatively, the indication may include a pop-up window or interstitial that is served to the visitor that allows he visitor to select or click on an option to view the advertisement.

One example pop-up window 308 is shown in FIG. 6. The pop-up window 308 is displayed on a Web page, such as the Web page 310 illustrated in FIG. 7, served during the step 104 and includes a button 312 on which a visitor may click to indicate a willingness to see or otherwise receive the advertisement that will be display in conjunction with the visitor entering a sweepstakes. In this case, the visitor must view the advertisement in order to enter the sweepstakes. The text in the balloon 313 could also ask “Would you like to view an Advertisement?,” “Would you like to enter a sweepstakes by watching a message from the sponsor of the sweepstakes?,” etc.

During a step 304, the server 202 receives an indication of the visitor's willingness to view the advertisement, such as an indication of a click on the button 312 on the pop-up window 308. The visitor may indicate an unwillingness to view the advertisement by clicking on the button 314 on the pop-up window 308.

After the server 202 receives the indication during the step 304, the server 202 may serve the advertisement to the visitor during the step 106 as previously discussed above. For example, the advertisement 122 and the Web page 124 illustrated in FIG. 3 may be served or displayed to the visitor.

Now referring to FIG. 8, a third embodiment 320 of a method in accordance with the present invention is illustrated. For purposes of explanation of the method 320, the server 202 will be assumed to be implementing the method 320. The method 320 includes the step 104 previously discussed above during which the server 202 serves a Web page, such as the Web page 310 illustrated in FIG. 7, to a visitor to a Web site.

The method 320 also includes a step 322 during which the server 202 serves or displays a branded component of an advertisement to the visitor. In some embodiments, the branded component may include a pop-up window or Web page on which a trademark or other information, image, etc. associated with a s sponsor of the advertisement is displayed. For example, a Web page may include the trademark of a particular company, such as illustrated by the Web page 324 of FIG. 9. The Web page 324 includes the trademark 326 of iWon, Inc., of Irvington, N.Y. In this example, the Web page does not include any other images or text other than the text message 327. If the Web page 324 is used in conjunction with the pop-up window 308 of FIGS. 6 and 7, the Web page 324 indicates that the sweepstakes mentioned in the pop-up window 308 is sponsored by iWon, Inc.

The Web page 324 focuses the visitor's interest and attention onto the company and brand represented by the trademark 326 and other information that may be displayed on the Web page 324. In some embodiments, the visitor may not be able to exit, close out, resize or minimize the Web page 324, thereby preventing the visitor from bypassing or avoiding the Web page 324 and creating even greater awareness of the brand and company represented by the trademark 326.

After the step 322, the server 202 may implement the step 328, during which a small form of an advertisement is displayed or served to the visitor. In some embodiments, the small form of the advertisement may be served or presented in a pop-up window or Web page. For example, a small form 330 of the print advertisement 120 previously discussed above may be shown in its own Web page 332, as illustrated in FIG. 10. In this example, the print advertisement 120 is used to create the Web advertisement 330. By showing a small form of the print advertisement 120, a visitor gets to see a copy of the entire print advertisement 120 at one time, thereby recreating the impression and impact of the print advertisement in an online or electronic environment. The visitor does not have to scroll the Web page in order to see the entire copy of the advertisement 330. In some embodiments, the visitor may not be able to scroll, exit, close out, resize or minimize the Web page 332, thereby preventing the visitor from bypassing or avoiding the Web page 332 and creating even greater awareness of the brand and company represented by the advertisement 330.

After the step 328, the server 202 may implement the step 334, during which a large form of an advertisement is displayed or served to the visitor. In some embodiments, the large form of the advertisement may be served in a pop-up window or Web page. A Web page displaying a large form of the print advertisement 120 maybe similar to that of Web page 332, with a larger version of the advertisement 330. In such a case, the large form of the advertisement may not be viewable without the visitor scrolling the Web page on which the advertisement is displayed. By displaying a larger version of the advertisement 330, the server 202 creates an even greater impression and impact for the visitor, even the visitor cannot see the entire advertisement at once. However, since the visitor has already seen the entire advertisement as a result of the step 328 and the Web page 332, the visitor is not confused when the larger form advertisement is served or displayed during the step 334.

In some embodiments, the large form ofthe advertisement displayed during the step 334 may be scrolled automatically in a window or Web page for the visitor, such as illustrated by the Web page 335 of FIG. 11, which is displaying a large form 336 of the advertisement 330 of FIG. 10. The large form advertisement 336 is shown as it might look on the Web page 335 after scrolling of the advertisement 336 has begun.

In some embodiments, the visitor may not be able to scroll, exit, close out or minimize the Web page 335, thereby preventing the visitor from bypassing or avoiding the Web page 335 and creating even greater awareness of the brand and company represented by the advertisement 336.

While the method 320 includes the display or serving of a brand component Web page, window, etc., a small form Web page, window, etc., and a large form Web page, window, etc., one of more of the steps 322, 328, 334 can be deleted or performed in alternative order. In addition, servings of other Web pages, windows, etc. may be included in the method 340. Other content, such as video streams, audio clips, graphics, text material, etc., may be included on one or more of the Web pages, windows, etc. displayed or served during the steps 322, 328 and/or 334. For example, a brand component served during the step 322 may include a audio message from the president of the company associated with the brand component, a video clip of employees of the company associated with the brand component, etc. In general, however, a brand component Web page, window, etc. will include minimal amount of content so as to focus a viewer as much as possible. In some embodiments, a brand component Web page or window may include a single logo or trademark or a single logo or trademark in conjunction with brief text message. The brand component Web page or window may be displayed full screen so as to focus attention on the logo, trademark, and or text message.

The Web pages, windows, etc. served during the steps 322, 328 and/or 334 may be displayed full screen on the visitors screen of a user device. In some embodiments, the Web pages, windows, etc served during the steps 322, 328 and/or 334 also may be implemented or configured such that they are not resizable (i.e., they have a fixed size), minimizable, closeable, etc. by the visitor using browser software operating on a user device (e.g., a computer).

Now referring to FIG. 12, a fourth embodiment 340 of a method in accordance with the present invention is illustrated. For purposes of explanation of the method 340, the server 202 will be assumed to be implementing the method 340. The method 340 includes the steps 104, 322, 328 and 334 previously discussed above.

The method 320 also includes a step 342 that happens after the step 104. During the step 342, one or more parameters for the brand component served during the step 322, the small form advertisement served during the step 328, and/or the large form advertisement served during the step 334 are determined or otherwise set. Parameters may include many things such as, for example, the length of time the brand component served during the step 322 is displayed; the length of time the small form advertisement served during the step 328 is displayed; the length of time the large form advertisement served during the step 334 is displayed; the type or duration of fade or transition used between the brand component, the small form advertisement served, and/or the large form advertisement; the scrolling speed of the large form advertisement; the length of time the large form advertisement is displayed before starting to scroll, the length of time the large form advertisement is displayed after scrolling, the dimensions ofthe small form advertisement, the dimensions of the large form advertisement, etc. In some embodiments, default parameters may be used for all advertisements served or displayed. In other embodiments, the parameters may change for each visitor, each advertisement, etc.

The server 202 may change on or more parameters for different visitors, times of day, advertisements, etc. In some embodiments, one or more parameters may be communicated to the server 202 from an ad server, advertiser or other device, entity or source. In some embodiments, if the server 202 knows or has access to any information about the visitor to a Web site, such as the visitor's age, advertisement click through history, duration of time visiting a specific Web site, duration of time viewing a specific Web page, gender, income, occupation, state of residence, personal preferences, shopping history, bank account balance, credit limit or history, homeowner status, marital status, etc., the server 202 may use such information in determining one or more of the parameters. Visitor information may be stored in a visitor database, which may be stored, updated, populated, maintained and/or accessed by the server 202, the database server 212, or some other device. Visitor information may be collected from a visitor as the visitor visits a Web site and supplies information, third party information collection agencies, direct marketing groups or mailing lists, publicly available records, etc.

In other embodiments, the server 202 may determine one or more parameters based, at least in part, on external events, such as the occurrence of a holiday, a designated rise or fall in the Dow Jones Industrial Average, the day of the week, a sale at a particular merchant, the season of year, the time of day, the number of visitors currently visiting a Web site or specific areas or pages of the Web site, the number of visitors currently viewing advertisements, the number of visitors currently viewing a specific advertisement, the willingness or unwillingness of visitors to view advertisements or a specific advertisement in the past, etc.

After the step 342 is completed, the steps 322, 328 and 334 may be implemented as previously described above in accordance with the parameters determined during the step 342. In some embodiments, all of the step 342 may be completed before the step 322. In other embodiments, the step 342 may not be completed until after the step 322 for parameters relevant to the steps 328 and 334 or even after the step 328 for parameters relevant to the step 334.

Now referring to FIG. 13, a fifth embodiment 360 of a method in accordance with the present invention is illustrated. For purposes of explanation of the method 360, the server 202 will be assumed to be implementing the method 360. The method 360 includes the steps 104, 302, 304, 322, 328 and 334 previously discussed above.

Now referring to FIG. 14, a sixth embodiment 380 of a method in accordance with the present invention is illustrated. For purposes of explanation of the method 380, the server 202 will be assumed to be implementing the method 380. The method 380 includes the steps 104, 322, 328 and 334 previously discussed above. In addition, the method 380 includes a step 382 during which a confirmation page, window, etc. is served or displayed to the visitor that enables the server 202 to determine if the visitor actually viewed one of more of the advertisements, Web pages, windows, etc. displayed during the steps 322, 328, and/or 334. For example, a confirmation Web page served during the step 382 may ask the viewer to answer questions about one or more of the advertisements, Web pages, windows, etc. displayed during the steps 322, 328 and/or 334. Alternatively, a confirmation Web page served during the step 382 may require the visitor to answer one or more questions within a specific period of time (e.g., ten seconds) after the confirmation Web page is displayed to the visitor. In this example, the short period of time to answer the questions limits the visitor's ability to not pay attention while Web pages, windows, advertisements, etc. are displayed during the steps 322, 328 and 334.

An example confirmation Web page 384 based on time is illustrated in FIG. 15. The Web page 384 includes an image 386 of the print advertisement 120, several questions for the visitor to answer, and the ability to submit responses to the questions by clicking on either of three submit buttons 388, 390 and 392. Each of the different submit buttons 388, 390, 392 also provides the visitor with different options such as, for example, saving a copy of the advertisement 386, emailing a copy of the print advertisement 386 to a friend, printing the advertisement 386, etc. If the visitor does not answer the questions on the Web page 384 and click one of the submit buttons 388, 390, 392 within a designated period of time, the Web page 384 may disappear.

As shown by the example Web page 384, answering the questions on the Web page 384 may entitle the visitor to receive entries in a sweepstakes, thereby providing motivation or incentive for the visitor to answer the questions. Other forms of compensation or reward may also be used, such as awarding frequent flyer miles, telephone calling minutes, rewards points redeemable in a loyalty program for the sponsor of the advertisement 386 or the Web site on which the advertisement is displayed, etc.

During a step 394, the server 202 may receive an indication of a confirmation that the visitor has viewed on or more of the advertisements, windows, Web pages, etc. displayed or served during the steps 322, 328, 334. For example, the visitor may click on one of the submit buttons 388, 390, 392 of the Web page 384 within a designated period of time, send an email message or other communication signal indicating confirmation, etc.

Now referring to FIG. 16, a seventh embodiment 400 of a method in accordance with the present invention is illustrated. For purposes of explanation of the method 400, the server 202 will be assumed to be implementing the method 400. The method 400 includes the steps 104, 322, 328, 334 and 382 previously discussed above. In addition, the method 380 includes a step 402 during which a visitor is given another opportunity to view or receive one of more of the advertisements, Web pages, windows, etc. displayed during one or more of the steps 322, 328 and 334.

The server 202 may provide the visitor with another opportunity to view one or more of the advertisements, Web pages, windows, etc. displayed during one or more of the steps 322, 328 and 334 if the visitor failed to provide a proper confirmation indication or if the step 394 of the method 380 is not received. For example, if the visitor is served the Web page 384 illustrated in FIG. 15, but the visitor does not click on one of the submit buttons 388, 390, 392 within a designated period of time, the server 202 may stop displaying the Web page 384 and instead display the Web page 404 illustrated in FIG. 17. The Web page 404 includes a button 406 on which the visitor can click to indicate the visitor's desire to see one or more of the advertisements, Web pages, windows, etc. displayed during one or more ofthe steps 322, 328 and 334. If the server 202 receives an indication that the visitor has clicked on the button 406, the method 400 may repeat one or more of the steps 322, 328 and/or 334.

While not specifically discussed above, each of the methods 320, 340, 360, 380 and 400 may include the step 102. Incorporating the step 102 into any of the methods 320, 340, 360, 380 and 400 further enhances the use of an electronic version of a print on a Web site.

While the methods described herein are discussed primarily from the point of view of the Web site server 202, it should be noted that complementary methods in accordance with the present invention can be implemented from the point of view of a user device that receives or downloads brand components, small form advertisements, large form advertisements, confirmation Web pages, and other windows, advertisements and Web pages. Thus, the Web pages, windows, indications and/or advertisements served during any of the steps 104, 106, 302, 322, 328, 334, 382 and/or 402 may be received by a user device, such as the user device 206. In addition, the user device 206 may send the indications received during the steps 304 and 394.

Now referring to FIG. 18, a representative block diagram of a Web site server, such as the server 202, is illustrated. The server 202 may include a processor, microchip, central processing unit, or computer 400 that is in communication with or otherwise uses or includes one or more communication ports 452 for communicating with user devices and/or other devices. Communication ports may include such things as local area network adapters, wireless communication devices, etc. The server 202 may also include an internal clock element 454 to maintain an accurate time and date for the server 202, create time stamps for search results received by or at the server 202, etc.

If desired, the server 202 may include one or more output devices 456 such as a printer, infrared or other transmitter, antenna, audio speaker, display screen or monitor, text to speech converter, etc., as well as one or more input devices 458 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 202 may include a memory or data storage device 460 to store information, software, databases, search terms, device drivers, navigation path options, etc. The memory or data storage device 460 preferably comprises an appropriate combination of magnetic, optical and/or semiconductor memory, and may include, for example, Random Access Memory (RAM), Read-Only Memory (ROM), a tape drive, flash memory, a floppy disk drive, a ZIP™ disk drive, a compact disc and/or a hard disk.

The processor 450 and the data storage device 460 in the server 202 may each be, for example: (i) located entirely within a single computer or other computing device; or (ii) connected to each other by a remote communication medium, such as a serial port cable, telephone line or radio frequency transceiver. In one embodiment, the server 202 may comprise one or more computers that are connected to a remote server computer for maintaining databases.

A conventional personal computer or workstation with sufficient memory and processing capability may be used as the server 202. In one embodiment, the server 202 operates as or includes a Web server for an Internet environment. The server 202 preferably is capable of high volume transaction processing, performing a significant number of mathematical calculations in processing communications and database searches. A Pentium™ microprocessor such as the Pentium III™ microprocessor, manufactured by Intel Corporation may be used for the processor 450. Equivalent processors are available from Motorola, Inc., AMD, or Sun Microsystems, Inc. The processor 450 may also comprise one or more microprocessors, computers, computer systems, etc.

Software may be resident and operating or operational on the server 202. The software may be stored on the data storage device 460 and may include a control program for operating the server, databases, etc. The control program may control the processor 450. The processor 450 preferably performs instructions of the control program, and thereby operates in accordance with the present invention, and particularly in accordance with the methods described in detail herein. The control program may be stored in a compressed, uncompiled and/or encrypted format. The control program furthermore includes program elements that may be necessary, such as an operating system, a database management system and device drivers for allowing the processor 450 to interface with peripheral devices, databases, etc. Appropriate program elements are known to those skilled in the art, and need not be described in detail herein. According to an embodiment of the present invention, the instructions of the control program may be read into a main memory from another computer-readable medium, such as from a ROM to RAM. Execution of sequences of the instructions in the control program causes the processor 450 to perform the process steps described herein. In alternative embodiments, hard-wired circuitry may be used in place of, or in combination with, software instructions for implementation of some or all of the methods of the present invention. Thus, embodiments of the present invention are not limited to any specific combination of hardware and software.

Now referring to FIG. 19, a representative block diagram of a user device, such as the user device 206, is illustrated. The user device 206 may include a processor, microchip, or computer 500 that is in communication with or otherwise uses or includes one or more communication ports 502 for communicating with Web site servers, database servers, etc. For example, the user device 206 may have an infrared or other transmitter as one communication port to allow the user device 206 to communicate with the server 202. In addition, if the user device 206 is connected to the server 202 via an Ethernet local area network, the user device 206 may include an Ethernet adapter as a communication port to allow the user device 206 to communicate with the server 202.

The user device 206 may include one or more output devices 504 for conveying information, such as a printer, audio speaker, infrared or other transmitter, antenna, display screen or monitor, text to speech converter, etc. The user device 206 may also include one or more input devices 506 for receiving information, such as a bar code reader or other optical scanner, infrared or other receiver, antenna, magnetic stripe reader, image scanner, roller ball, touch pad, joystick, touch screen, microphone, computer keyboard, computer mouse, etc. The user device 206 may also include a fingerprint scanner or reader, a retinal scanner, a voice analyzer, or other biometrics data input device as an input device 506 to allow the user device 206 to identify users of the user device 206.

In addition to the above, the user device 206 may include a memory or data storage device 508 to store information, software, databases, device drivers, user information, search terms, browsers, computer software, operating systems, advertisements, etc. The memory or data storage device 508 preferably comprises an appropriate combination of magnetic, optical and/or semiconductor memory, and may include, for example, Random Access Memory (RAM), Read-Only Memory (ROM), a tape drive, flash memory, a floppy disk drive, a Zip™ disk drive, a compact disc and/or a hard disk.

The user device 206 may also include an internal clock element 510 to maintain an accurate time and date for the user device 206, create time stamps for information, search requests, cookies, advertisements, etc. generated or received via the user device 206.

As previously discussed above, possible user devices include a personal computer, portable computer, mobile or fixed user station, workstation, network terminal or server, telephone, beeper, kiosk, dumb terminal, personal digital assistant, facsimile machine, etc. If desired, the user device 206 may also function as the server 202.

The ad server 212 may have the same configuration as either the Web site server 202 or the user device 206. Therefore, further discussion of the components of the ad server 212 is not necessary.

The foregoing description is considered as illustrative only of the principles of the invention. Furthermore, since numerous modifications and changes will readily occur to those skilled in the art, it is not desired to limit the invention to the exact construction and process shown and described above. Accordingly, all suitable modifications and equivalents may be resorted to falling within the scope of the invention as defined by the claims which follow. Further, even though only certain embodiments have been described in detail, those having ordinary skill in the art will certainly understand that many modifications are possible without departing from the teachings thereof. All such modifications are intended to be encompassed within the following claims.

The present invention may be embodied as a computer program developed using an object oriented language that allows the modeling of complex systems with modular objects to create abstractions that are representative of real world, physical objects and their interrelationships. However, it would be understood by one of ordinary skill in the art that the invention as described herein can be implemented in many different ways using a wide range of programming techniques as well as general purpose hardware systems or dedicated controllers. In addition, many, if not all, of the steps for the methods described above are optional or can be combined or performed in one or more alternative orders or sequences without departing from the scope of the present invention and the claims should not be construed as being limited to any particular order or sequence, unless specifically indicated.

While specific implementations and hardware configurations for Web site servers and user devices have been illustrated, it should be noted that other implementations and hardware configurations are possible and that no specific implementation or hardware configuration is needed. Therefore, many different types of implementations or hardware configurations can be used in the system 200 and the methods disclosed herein are not limited to any specific hardware configuration.

Each of the methods described above can be performed on a single computer, computer system, microprocessor, etc. In addition, two or more of the steps in each of the methods described above could be performed on two or more different computers, computer systems, microprocessors, etc., some or all of which may be locally or remotely configured. The methods can be implemented in any sort or implementation of computer software, program, sets of instructions, code, ASIC, or specially designed chips, logic gates, or other hardware structured to directly effect or implement such software, programs, sets of instructions or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

The terms “computer-readable medium,” “computer program,” “computer software,” “software” and “program” as used herein refers to any medium that directly or indirectly participates in providing instructions to a processor for execution. Such a medium may take many forms, including but not limited to, non-volatile media, volatile media, and transmission media. Non-volatile media include, for example, optical or magnetic disks. Volatile media include dynamic random access memory (DRAM), which typically constitutes the main memory. Transmission media include coaxial cables, copper wire and fiber optics, including the wires that comprise a system bus coupled to a processor. Transmission media can also take the form of acoustic, electrical or electromagnetic waves, such as those generated during radio frequency (RF) and infrared (IR) data communications.

The connections or communications between user devices, Web site servers, and database servers discussed herein is only meant to be generally representative of cable, computer, telephone, or other communication or data networks and methods for purposes of elaboration and explanation of the present. The connections are also intended to be representative of, and include all or a part of, the Internet, the World Wide Web, and other privately or publicly operated networks, including wide area networks, local area networks, data communication networks or connections, intranets, routers, satellite links or networks, microwave links or networks, cellular telephone or radio links, fiber optic transmission lines, ISDN lines, T1 lines, etc. In addition, as used herein, the terms “computer,” “user device,” “terminal,” “client,” “device” and “client device” are generally interchangeable and are meant to be construed broadly and to include, but not be limited to, all clients, client devices or machines, personal digital assistants and palm top computers, cash registers, terminals, computers, point-of-sale devices, processors, servers, etc. connected or connectable to a computer or data communications network and all devices on which Internet-enabled software, such as the NETSCAPE COMMUNICATOR™ or NAVIGATOR™ browsers, MOSIAC™ browser, or MICROSOFT INTERNET EXPLORER™ browsers, can operate or be run. The term “browser” should also be interpreted as including Internet-enabled software and computer or client software that enables or allows communication over a computer network and Internet-enabled or World Wide Web enabled, monitored, or controlled devices such as WebTV™ devices, game consoles, household appliances, phones, etc.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

The embodiments of the invention in which an exclusive property or privilege is claimed are defined as follows:

1. A method for serving an electronic version of a print advertisement on a World Wide Web site, comprising:
preparing an electronic version of a print advertisement;
serving a Web page; and
serving a full form of said print advertisement on said Web page.

2. The method of claim 1, further comprising:
providing an indication of an opportunity to view said electronic version of said print advertisement; and
receiving an indication of a willingness to view said electronic version of said print advertisement.

3. The method of claim 2, wherein said providing an indication of an opportunity to view said electronic version of said print advertisement includes serving at least one of the following:
a pop-up window on which a willingness to receive said electronic version of said print advertisement can be indicated; and
a Web page on which a willingness to receive said electronic version of said print advertisement can be indicated.

4. The method of claim 1, wherein said preparing an electronic version of said print advertisement includes receiving said electronic version of said print advertisement.

5. The method of claim 1, further comprising:
providing an indication of an opportunity to participate in a sweepstakes; and
receiving an indication of an interest in participating in said sweepstakes.

6. The method of claim 1, wherein said serving said full form of said electronic version of said print advertisement includes scrolling said electronic version of said print advertisement on a Web page.

7. A system for serving an electronic version of a print advertisement on a World Wide Web site, comprising:
a memory;
a communication port; and
a processor connected to said memory and said communication port, said processor being operative to:
prepare an electronic version of a print advertisement;
serve a Web page; and
serve a full form of said print advertisement on said Web page.

8. A computer readable medium for use in a server hosting a World Wide Web site, the computer readable medium storing a computer program comprising:
computer readable means for establishing an electronic version of a print advertisement;
computer readable means for downloading a Web page; and
computer readable means for downloading a full form of said print advertisement on said Web page.

9. An apparatus for serving an advertisement, comprising:
means for establishing an electronic version of a print advertisement;
means for downloading a Web page; and
means for downloading a full form of said print advertisement on said Web page.

10. A method for serving an advertisement on a World Wide Web site, comprising:
serving a brand component on at least one of a window or Web page;
serving a small form of an advertisement on at least one of a window or Web page; and
serving a large form of said advertisement on at least one of a window or Web page.

11. The method of claim 10, further comprising:
preparing an electronic version of a print advertisement.

12. The method of claim 10, further comprising:
determining at least one display parameter.

13. The method of claim 10, further comprising:
providing an indication of an opportunity to view said advertisement; and
receiving an indication of a willingness to view said advertisement.

14. The method of claim 10, further comprising:
serving at least one of window or Web page requesting confirmation of a viewing of at least one of said brand component, said small form of said advertisement and said large form of said advertisement.

15. The method of claim 14, wherein said at least one of a window or Web page requesting confirmation is displayed for a fixed period of time.

16. The method of claim 10, further comprising:
receiving an indication of a confirmation of a viewing of at least one of said brand component, said small form of said advertisement, and said large form of said advertisement.

17. The method of claim 10, wherein said brand component is displayed for a fixed period of time.

18. The method of claim 10, wherein said small form of said advertisement is displayed for a fixed period of time.

19. The method of claim 10, wherein said large form of said advertisement is displayed for a fixed period of time.

20. The method of claim 10, wherein said large from of said advertisement is scrolled on at least one of a window or Web page.

21. The method of claim 10, further comprising:
receiving an indication of a willingness to view at least one of said brand component, said small form of said advertisement, and said large form of said advertisement.

22. A system for serving an advertisement on a World Wide Web site, comprising:
a memory;
a communication port; and
a processor connected to said memory and said communication port, said processor being operative to:
serve a brand component in at least one of a window or Web page;
serve a small form of an advertisement in at least one of a window or Web page; and
serve a large form of said advertisement in at least one of a window of Web page.

23. A computer readable medium for use in a server hosting a World Wide Web site, the computer readable medium storing a computer program comprising:
computer readable means for providing a brand component;
computer readable means for providing a small form of an advertisement; and
computer readable means for providing a large form of said advertisement.

24. An apparatus for serving an advertisement, comprising:
means for providing a brand component;
means for providing a small form of an advertisement; and
means for providing a large form of said advertisement.

25. A method for serving an electronic version of a print advertisement on a World Wide Web site, comprising:
preparing an electronic version of a print advertisement;
serving a Web page; and
serving at least a portion of said electronic version of said print advertisement on said Web page.

26. The method of claim 25, wherein said electronic version of said print advertisement is representative of an unmodified version of said print advertisement.

27. The method of claim 25, wherein said electronic version of said print advertisement is representative of a modified version of said print advertisement.

28. A method for serving an advertisement on a World Wide Web site, comprising:
serving a first Web page having a brand component, wherein said first Web page is not resizable by a viewer using browser software; and
serving a second Web page having a first form of an advertisement such that said first Web page is not viewable to said viewer.

29. The method of claim 28, wherein said second Web page is not resizable by a viewer using browser software

30. The method of claim 28, further comprising:
serving a third Web page having a second form of said advertisement such that said second Web page is not viewable to said viewer.

31. The method of claim 30, wherein said third Web page is not resizable by a viewer using browser software.

32. A method for serving an advertisement on a World Wide Web site, comprising:
serving a first Web page having a first form of an advertisement, wherein said first Web page is not resizable by a viewer using browser software; and
serving a second Web page having a second form of said advertisement such that said first Web page is not viewable to said viewer.

33. The method of claim 32, wherein said first Web page is not resizable by a viewer using browser software.

34. The method of claim 32, wherein said second Web page is not resizable by a viewer using browser software.

35. The method of claim 32, wherein said first Web page is configured so that it is displayed full screen when it is displayed on a user device.

36. The method of claim 32, wherein said second Web page is configured so that it is displayed full screen when it is displayed on a user device.

37. A method for serving an advertisement on a World Wide Web site, comprising:
serving a first window having a brand component, wherein said first window is not resizable by a viewer using browser software; and
serving a second window having a first form of an advertisement such that said first window is not viewable to said viewer.

38. The method of claim 37, wherein said second window is not resizable.

39. The method of claim 37, further comprising:
serving a third window having a second form of said advertisement such that said second window is not viewable to said viewer.

40. The method of claim 37, wherein said third window is not resizable.

41. A method for serving an advertisement on a World Wide Web site, comprising:
serving a first window having a first form of an advertisement, wherein said first window is not resizable; and
serving a second window having a second form of said advertisement such that said first window is not viewable to said viewer.

42. The method of claim 41, wherein said first window has a fixed size.

43. The method of claim 41, wherein said second window has a fixed size.

44. The method of claim 41, wherein said first window is configured to be displayed full screen when it is displayed on a user device.

45. The method of claim 41, wherein said second window is configured to be displayed full screen when it is displayed on a user device.

46. A method for serving an advertisement, comprising:
serving at least one of a first window or Web page having a brand component, wherein said at least one of a window or Web page is configured to display for a period of time when it is displayed on a user device; and
after said period of time has elapsed, automatically serving at least one of a second window or Web page having a first form of said advertisement, wherein said at least one of a second window of Web page is configured such that said at least one of a second window or Web page is displayed full screen when it is displayed on said user device.

47. A method for serving an advertisement, comprising:
serving at least one of a first window or Web page having a first form of an advertisement, wherein said at least one of a first window or Web page is configured to display for a period of time when displayed on a user device; and
after said period of time has elapsed, automatically serving at least one of a second window or Web page having a second form of said advertisement, wherein said at least one of said second window or Web page is configured to display full screen when it is displayed on said user device.

48. A method for serving an advertisement, comprising serving at least one of a window or Web page having an advertisement, wherein said at least one of a window or Web page is configured to display for a first period of time on a user device and to display full screen on said user device, wherein said at least one of a window or Web page is configured so that it is not resizable during at least a portion said first period of time.

49. The method of claim 48, wherein said first form of an advertisement is an electronic version of a print advertisement.

50. The method of claim 48, wherein said at least one of a window or Web page is configured such that said first form of said advertisement automatically scrolls on said at least one of a window or Web page after said at least one of a window or Web page is displayed on said user device for a second period of time.

51. Computer software for use in displaying an advertisement, comprising computer software operative to display at least one of a window or Web page having an advertisement, wherein said at least one of a window or Web page is configured to display for a period of time on a user device and to display full screen when it is displayed on said user device, wherein said at least one of a window or Web page also is configured so that it has a fixed size during at least a portion said period of time.

52. Computer software for use in displaying an advertisement, comprising computer software operative to:
display at least one of a first window or Web page having a first form of an advertisement, wherein said at least one of a window or Web page is configured to display for a period of time on a user device; and
after said period of time has elapsed, automatically display at least one of a second window or Web page having a second form of said advertisement such that said at least one of a second window or Web page is displayed full screen when displayed on said user device.

53. A method for serving an advertisement, comprising serving at least one of a window or Web page having an advertisement, wherein said at least one of a window or Web page is configured to display full screen on a user device for a period of time, wherein said at least one of a window or Web page is configured so that it is not resizable with browser software during at least a portion of said period of time, and wherein said at least one of a window of Web page is configured to scroll said advertisement.

54. Computer software for use in displaying an advertisement, comprising computer software operative to display at least one of a window or Web page having an advertisement on a user device, wherein said at least one of a window or Web page is configured to display full screen on said user device for a period of time, wherein said at least one of a window or Web page is configured so that it has a fixed size during at least a portion said period of time, and wherein said at least one of a window of Web page is configured to scroll said advertisement.

55. A method for serving an advertisement, comprising:
serving at least one of a first window or Web page having a first form of an advertisement, wherein said at least one of a first window or Web page is configured to display full screen for a first period of time on a user device and has a fixed size during said first period of time; and
after said period of time has elapsed, automatically serving at least one of a second window or Web page having a second form of said advertisement, wherein said at least one of a second window or Web page is configured to display full screen on said user device for a second period of time and has a fixed size during said second period of time.
